(19) United States
(12) Patent Application Publication
(10) Pub. No.: US 2026/0166990 A1
(43) Pub. Date: Jun. 18, 2026

(54) Method for adjusting a motor vehicle component

(71) Applicant: AUDI AG, Ingolstadt (DE)

(72) Inventor: Daniel LOTTES, Ihrlerstein (DE)

(73) Assignee: AUDI AG, Ingolstadt (DE)

(21) Appl. No.: 19/424,709

(22) Filed: Dec. 18, 2025

(30) Foreign Application Priority Data
Dec. 18, 2024 (DE) 10 2024 138 728.9

(51) Int. Cl. B60K 35/10; B60K 35/21

(52) U.S. Cl. CPC B60K 35/10; B60K 35/212; B60K 2360/126; B60K 2360/1446; B60K 2360/741

(57) ABSTRACT

A method of adjusting a motor vehicle component, a system, a computer program, a computer-readable storage medium and a motor vehicle, may include a sensor device configured to establish a first user input and second user input of a user. A processing device may be configured to adjust the motor vehicle component based on a parameter selected by the user.

### CROSS-REFERENCE TO RELATED APPLICATIONS

This application claims the priority benefit of German Patent Application No. 10 2024 138 728.9 filed on Dec. 18, 2024, which is incorporated by reference herein in its entirety.

### BACKGROUND

### 1. Field

An invention according to described examples relates to a method for adjusting a motor vehicle component, to a system, to a computer program, to a computer-readable storage medium and to a motor vehicle.

### 2. Description of Related Art

There are various user control options for operating electronic components such as an air conditioning system or a multimedia system of a motor vehicle. For example, there are rotary controls directly on the components. However, it is also common for buttons and keys to be arranged on the steering wheel of the motor vehicle so that the user can make adjustments to the respective apparatus or systems via these input options. In this context, there are now also so-called rotary pushbuttons, which are often located in the area of the center console, i.e. between the driver's seat and the front passenger's seat. These usually have a rotary knob, which can be used to select between different control options. Furthermore, these are arranged so that a user of the rotary pushbutton can perform longitudinal movements of the rotary pushbutton, in particular in the vehicle direction. These are used, for example, to push in a first direction to confirm an adjustment or in a movement of the rotary pushbutton opposite to the first direction to reverse an adjustment.

### SUMMARY

Therefore, it is an example object of the present invention according to the examples to improve the adjustment of a component of a motor vehicle. In particular, in this context, the example object may be to simplify the operation of the electronic component in order to allow the user of the motor vehicle to keep as low as possible the period of time for which the user has to take at least one hand away from the steering wheel in order to control the component.

The example object may be achieved by a method for adjusting a motor vehicle component, a system, a computer program, a computer-readable storage medium and a motor vehicle.

A first aspect relates to a method for adjusting a motor vehicle component. In a first step, at least one first user input of a user is detected by way of at least one sensor device, the detection being performed by way of at least one capacitive sensor of the sensor device. A first parameter and at least one second parameter are then displayed by way of a visual output device based on the detected user input in a predetermined area, the first parameter indicating a first adjustment of the motor vehicle component and the second parameter indicating a second adjustment of the motor vehicle component. On the basis thereof, a field of vision visually targeted by the user in the predetermined area of the output device is ascertained depending on a time when the first parameter and the second parameter have been presented by way of an image capturing device, and a parameter selected by the user based on the ascertained targeted field of vision is determined depending on a spatial arrangement of the presented first parameter and the presented second parameter in the field of vision of the user by way of a processing device, the selected parameter corresponding either to the first parameter or to the second parameter. A second user input of the user is also established by way of the sensor device depending on a time when the targeted field of vision of the user has been ascertained by way of the image capturing device. On the basis thereof, the motor vehicle component is adjusted by way of the processing device based on the particular parameter selected by the user after the second user input has been established. Said method is a computer-implemented method.

The invention according to the examples is based on the idea of providing an improved operating concept by which electronic components can be controlled by glances and using a rotary pushbutton (abbreviated to RPB). A rotary pushbutton is equipped with capacitive sensors. In addition, the rotary pushbutton can be moved in the vehicle direction, in particular in the longitudinal direction of the motor vehicle, which can trigger a confirmation (click). When a user's body part, such as a finger, is placed on the RPB, a menu appears. The menu items or lists can be “swiped through” by turning the scroll wheel of the RPB. Individual menu items can be selected using the eyes. A confirmation can be made by “sliding back” the RPB. As an alternative, other user confirmations are also possible. “Back” can be represented by a separate menu item able to be selected using the eyes and chosen by “Push RPB”.

A second aspect relates to a system for adjusting a motor vehicle component. The sensor has at least one sensor device configured to detect at least one first user input of a user by way of at least one capacitive sensor. The system also has a visual output device configured to present a first parameter and at least one second parameter based on the detected user input in a predetermined area, the first parameter indicating a first adjustment of the motor vehicle component and the second parameter indicating a second adjustment of the motor vehicle component. An image capturing device of the system is configured to ascertain a field of vision visually targeted by the user in a predetermined area of the output device depending on a time when the first parameter and the second parameter have been presented. A processing device is furthermore configured to determine a parameter selected by the user based on the ascertained targeted field of vision depending on a spatial arrangement of the presented first parameter and the presented second parameter in the field of vision of the user, the selected parameter corresponding either to the first parameter or to the second parameter. In this case, the sensor device is configured to establish a second user input of the user depending on a time when the targeted field of vision of the user has been ascertained by way of the image capturing device. The processing device is also configured to adjust the motor vehicle component based on the particular parameter selected by the user after the second user input has been established.

A third aspect relates to a computer program which, when the program is executed by a computer, causes the computer to execute the method according to the first aspect.

A fourth aspect relates to a computer-readable storage medium, comprising instructions which, when executed by a computer, cause the computer to perform the method according to the first aspect.

A fifth aspect relates to a motor vehicle, comprising a computer processor configured to execute the method according to the first aspect, a system according to the second aspect, a computer program according to the third aspect, or a computer-readable storage medium according to the fourth aspect.

According to an example, the sensor device is in the form of a rotary pushbutton. The configuration of the sensor device as a rotary pushbutton not only enables a simple mechanical movement of the rotary pushbutton, as is already known. Rather, it is additionally possible to ascertain user inputs by way of the capacitive sensor, which would be discounted by merely mechanical movement of the rotary pushbutton.

According to another example, the sensor device is arranged in an operating position in a motor vehicle in the area of the center console. Specifically arranging the sensor device, in particular the rotary pushbutton, in the area of the center console can achieve a situation in which the motor vehicle can still be operated by the user intuitively. For example, the user is accustomed to making adjustments to the motor vehicle in the area of the center console, such as shifting the transmission.

According to another example, the sensor device additionally comprises at least one infrared sensor configured to ascertain a distance from a body part of the user. Infrared sensors are characterized in that they are able in particular to ascertain the distance between the infrared sensor and a body part of the user. By combining a capacitive sensor and an infrared sensor, in this context it is possible to achieve a situation in which the user input can be ascertained particularly precisely.

According to another example, the method comprises the following additional step: preparing the image capturing device and/or the processing device to be able to perform at least one of the following steps within a predetermined period when a distance from a body part of the user ascertained by way of the infrared sensor falls below a predetermined threshold value: ascertaining the field of vision visually targeted by the user, determining the parameter selected by the user, establishing the second user input of the user.

In this way, it is possible that the system can already be prepared for a user input to be made immediately. This means that various devices in the system can be brought into an active state in advance, if this has not already been done. For example, in this context, it is possible that the image capturing device is in a standby mode, that is to say it does not continuously detect the user of the motor vehicle. On the one hand, this may be desirable in order to ensure that the user does not feel constantly observed. On the other hand, it may be advantageous not to leave certain devices of the system permanently in an active state, in particular to save battery capacities. This is particularly important for essentially electrically operated vehicles, as they have limited electrical energy available.

According to another example, the sensor device additionally comprises a microphone configured to ascertain at least one sound from the user. Thus, it is additionally possible for a user to control the component of the motor vehicle at least in part by voice control. In this way, the period of time within which the user must take their right hand away from the steering wheel can be reduced, in particular minimized.

According to another example, the output device is in the form of at least one of the following devices: head-up display, black-print display, steering wheel display. These mentioned embodiments of output devices are essentially known to the user of the motor vehicle. The additional use of these output devices for controlling the electronic components in connection with the sensor device can make particularly comfortable operation possible. Furthermore, these component parts are often already installed in the vehicle and so no additional components are required.

According to another example, the method comprises the following additional step: identifying a predetermined movement of a body part of the user during the user input detected by way of the sensor device. For example, the sensor device can determine a certain finger gesture performed by the user on the sensor device. In a first example, the user may, for example, draw a first pattern on the sensor device using their index finger, which pattern relates to a first functionality of the electronic component. By drawing a second pattern that is different from the first pattern, the user can adjust another functionality of the electronic component.

According to another example, the step of identifying the predetermined movement is carried out based on the capacitive sensor and/or the infrared sensor of the sensor device. If the infrared sensor is configured to also detect a movement of the user's body part, it is possible to enable the user not to be prompted to touch the sensor device. Infrared sensors are characterized in that they can also identify movements of the body part within a predetermined distance between the sensor and the body part. This simplifies the operation of the sensor device and, in general, the control of the vehicle component. If the identification step is carried out by the capacitive sensor as well as the infrared sensor, particularly accurate identification of the predetermined movement of the user can be made possible. In this context, this reduces inaccurate user inputs in particular, which can additionally increase user comfort.

According to another example, the method comprises the following additional step: identifying one or more body parts of the user which are used by the user when detecting the first user input and/or the second user input. For example, by placing their index finger, the user can communicate a first instruction for adjusting the vehicle component, whereas the placement of the index finger and middle finger signal to the system that a second instruction is to be performed. In this context, the entire device may be configured to be able to perform a predetermined function on the basis of the fingerprint of the user. Furthermore, it is also possible that the user can combine certain functions with certain fingers, that is to say that a first function is preassigned by placing the index finger, whereas a second function is preassigned by placing the middle finger. Thus, the user can teach the system, which can make the control or adjustment of the vehicle component particularly simple and intuitive.

Generally speaking, another example may include in that the sensor device is configured to identify and distinguish a first body part and a second body part. Depending on which body part has been identified, provision may be made for a first parameter set having a first parameter and a second parameter to be presented for the first body part and a second parameter set having a third parameter and a fourth parameter to be presented for the second body part. Each parameter, in turn, indicates an individual adjustment of the vehicle component. For example, by placing the first body part, such as the index finger, on the sensor device, the system can be influenced to display a menu with regard to the volume control of the multimedia system. Whereas the placement of the middle finger on the sensor device influences the system to display a menu regarding the adjustment of the chassis.

According to another example, the step of establishing a second user input is carried out by way of at least one of the following sensors of the sensor device: the capacitive sensor of the sensor device, the infrared sensor, a movement sensor configured to establish a movement of the sensor device. In this way, different types of user input can be established separately or together. In addition, rotational, pushing, pulling and sliding movements of the sensor device can also be established. This increases the range of inputs from the user that can potentially be established.

For applications or application situations which may arise for the method and are not explicitly described here, there can be provision for the method to involve an error message and/or a request to input user feedback being output and/or a default setting and/or a predetermined initial state being set.

The invention according to the examples also includes the control apparatus or processing device for the motor vehicle. The control apparatus can comprise a data processing apparatus or a processor device (processor circuit) configured to carry out an the method according to the examples of the invention. For this purpose, the processor device can have at least one microprocessor and/or at least one microcontroller and/or at least one FPGA (field-programmable gate array) and/or at least one DSP (digital signal processor). In particular, a CPU (central processing unit), a GPU (graphical processing unit) or an NPU (neural processing unit) can each be used as the microprocessor. In addition, the processor device can have program code configured so as, when executed by the processor device, to carry out the method according to the examples of the invention. The program code may be stored in a data memory of the processor device. The processor device can be based e.g. on at least one circuit board and/or on at least one SoC (system on chip).

The invention according to the examples also includes developments of the method according to the examples of the invention which have features as have already been described in connection with the developments of the motor vehicle according to the examples of the invention. For this reason, the corresponding developments of the method according to the examples of the invention are not described again here.

The motor vehicle according to the examples of the invention may be a motor car, in particular a passenger car or truck, or in the form of a minibus or motorcycle.

As a further solution, the invention according to the examples also comprises a computer-readable storage medium comprising program code which, when executed by a computer or a computer network, causes it to carry out the method according to the examples of the invention. The storage medium may be provided at least partially as a non-volatile data memory (for example as a flash memory and/or as an SSD—solid state drive) and/or at least partially as a volatile data memory (for example as a RAM—random access memory). The storage medium may be arranged in the computer or computer network. However, the storage medium may also be operated, for example, as what is known as an app store server and/or cloud server on the Internet. The computer or computer network can be used to provide a processor circuit with, for example, at least one microprocessor. The program code may be provided as binary code and/or as assembler code and/or as source code of a programming language (for example C) and/or as a program script (for example Python). The computer-readable storage medium can alternatively be realized by a signal with computer-readable data, e.g. a time-varying voltage signal and/or a radio signal.

The invention according to the examples also comprises the combinations of the features of the described examples. The invention according to the examples thus also comprises implementations that each have a combination of the features of several of the described examples, unless the examples have been described as being mutually exclusive.

### BRIEF DESCRIPTION OF THE DRAWINGS

Examples of the invention are described below. In this regard:

FIG. 1 shows an example of a flowchart with respect to a method for adjusting a motor vehicle component;

FIG. 2 shows an exemplary sensor device;

FIG. 3 shows an exemplary system for adjusting a motor vehicle component; and

FIG. 4 shows a system for adjusting a motor vehicle component in an operating position in a motor vehicle, according an example.

### DESCRIPTION

The examples explained below are examples of the invention. In the examples, the described components of the examples each represent individual features of the examples of the invention that should be considered independently of one another and that each also develop the examples of the invention independently of one another. The disclosure is therefore also intended to comprise combinations of the features of the examples other than those illustrated. In addition, the described examples can also be supplemented by more of the features of the examples of the invention that have already been described.

In the figures, identical reference signs denote functionally identical elements in each case.

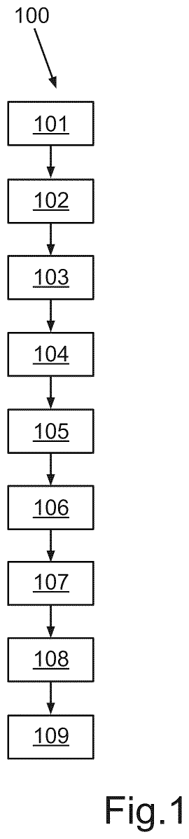

FIG. 1 shows an example of a flowchart with respect to a method 100 for adjusting a motor vehicle component 1.

In a first step 101, a capacitive sensor 4 of a sensor device 3 identifies one or more body parts of a user 2 which are used in a first user input of a user or a second user input of the user. In this case, the sensor device 3 may additionally comprise an infrared sensor 5 by which the body part of the user 2 can be identified. In this case, it is advantageous if the infrared sensor 5 can already ascertain a body part of the user 2 located in the vicinity of the sensor device 3 and thus a distance between the body part 2 and the infrared sensor 5.

On the basis of step 101, an image capturing device 9 and/or a processing device 11 can be prepared 102. In this case, it is considered that one of the two devices 9 and 11 is capable of carrying out steps to be carried out later within a predetermined period of time. In this context, provision may be made for the image capturing device 9 or the processing device 11 to transition from an inactive standby mode, in which the devices 9 or 11 have at least a reduced energy consumption, to an active state, in which they are essentially fully functional. Step 102 is then carried out when a distance from the body part of the user 2 that is ascertained by the infrared sensor 5 falls below a predetermined threshold value. For example, provision may be made for step 102 to be carried out when a hand of the user is located at a distance from the infrared sensor 5 of less than 10 cm.

Subsequently, at least one user input of the user is detected 103 by way of at least one capacitive sensor 4 of the sensor device 3. A predetermined movement of a body part of the user 2 during the user input may be identified 104, while the user input is detected by way of the sensor device 3. This can be done on the basis of the capacitive sensor 4 and/or on the basis of an infrared sensor 5 of the sensor device 3.

Subsequently, a first parameter P1 and at least one second parameter P2 are presented 105 by way of a visual output device 7 based on the detected user input in a predetermined area 8, the first parameter P1 indicating a first adjustment of the motor vehicle component 1 and the second parameter P2 indicating a second adjustment of the motor vehicle component 1.

In another step 106, a field of vision 10 visually targeted by the user in the predetermined area 8 of the output device 7 is ascertained depending on a time when the first parameter P1 and the second parameter P2 have been presented by way of an image acquisition device 9. On this basis, a parameter selected by the user is determined 107 on the basis of the ascertained targeted field of vision 10, this being carried out depending on a spatial arrangement of the presented first parameter P1 and the presented second parameter P2 in the field of vision 10 of the user by way of a processing device 11. The selected parameter corresponds to the first parameter P1 or the second parameter P2. In another step 108, a second user input made by the user is established by way of the sensor device 3. Step 108 may be carried out based on the capacitive sensor 4, the infrared sensor 5 and/or the motion sensor 6. This happens in this case depending on a time when the targeted field of vision 10 of the user has been ascertained by way of the image capturing device 9. After the second user input has been established, the motor vehicle component 1 is adjusted 109 by way of the processing device 11 on the basis of the particular parameter selected by the user.

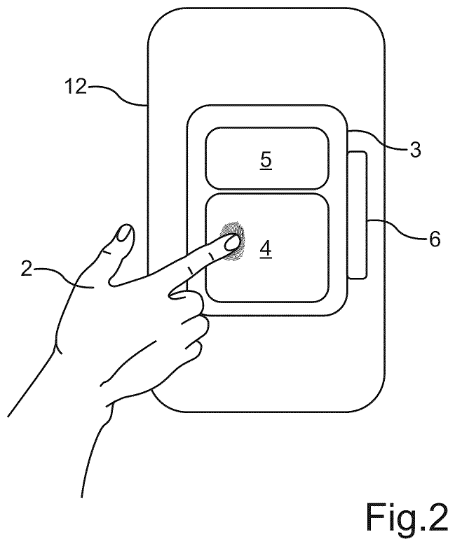

FIG. 2 shows an exemplary sensor device 3 of the system 20. As illustrated, the sensor device 3 is arranged at or on the center console 12. The sensor device 3 in turn has at least one capacitive sensor 4 configured to detect a user input of the user. As illustrated, it may be possible in this context that contact by a finger of the user with the capacitive sensor 4 can be established. In particular, the capacitive sensor 4 is configured to identify a fingerprint of the user. The fingerprint can be used here to make a specific selection regarding the first parameter P1 and the second parameter P2 selectable.

Furthermore, the sensor device 3 comprises an infrared sensor 5 configured to additionally identify the body part of the user 2. In this context, it may be possible, on the one hand, that the infrared sensor 5 is configured to establish the shape of the body part 2. Alternatively or additionally, the infrared sensor 5 may also be configured to determine the distance between the body part 2 and the infrared sensor 5.

The sensor device 3 may also have a motion sensor 6 configured to establish a movement of the sensor device 3 in a longitudinal direction. For example, provision may be made for the user to be able to slide or move the sensor device 3 by a predetermined path in a first direction and by a predetermined path in a second direction opposite to the first direction.

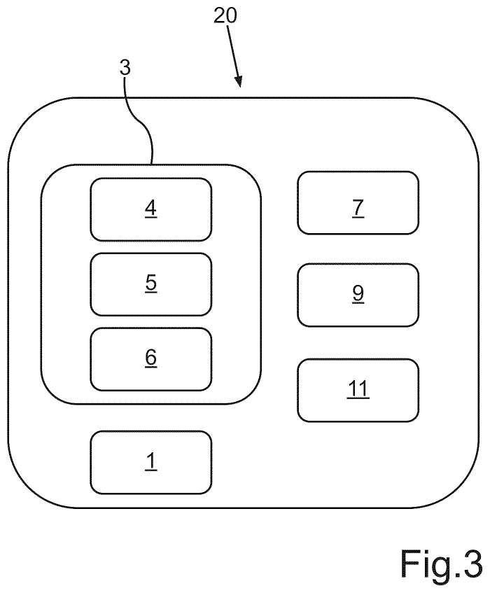

FIG. 3 shows an exemplary system 20 for adjusting a motor vehicle component 1. The system 20 comprises, as illustrated, the sensor device 3, which may comprise at least the capacitive sensor 4, the infrared sensor 5 and the motion sensor 6. In this context, it may be that several of the enumerated sensors are arranged in the sensor device 3. The fact that the more sensors that are arranged in the sensor device 3, the more the accuracy can be increased can be taken into account here.

Furthermore, the motor vehicle component 1 may be part of the system 20, which may be in the form of a sound system, navigation device or a hands-free device, for example. In order to be able to ensure a particularly convenient interaction with the user, the system 20 additionally has a visual output device 7. This may be in the form of a head-up display, a black-print display or a steering wheel display, for example. In order to be able to ascertain a field of vision 10 targeted by a user, the system 20 additionally comprises an image capturing device 9. Said image capturing device may be in the form of a camera, for example, which in particular can analyze the eyes of the user and their pupils accordingly. Based on this, a field of view 10 of the user can be approximated.

In order to be able to perform these calculations, the system 20 additionally has a processing device 11. This may be a control device of the motor vehicle or else an additional computer on or in the motor vehicle. Furthermore, it is also possible that specific calculations can be outsourced to a computer that can be accessed via a cloud.

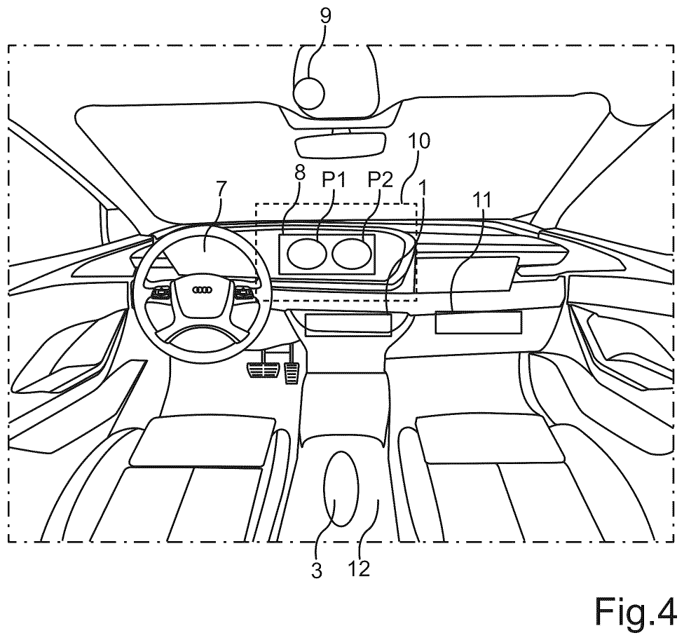

FIG. 4 shows the system 20 for adjusting a motor vehicle component 1 in an operating position in a motor vehicle, according to an example. As can be seen in FIG. 4, an interior of a motor vehicle is illustrated. The sensor device 3 is arranged between two front seats in the area of a center console 12. In this context, the sensor device 3 may be in the form of a rotary pushbutton. Furthermore, the motor vehicle comprises further component parts of the system 20. The motor vehicle component 1 is arranged above the sensor device 3. Said component is an air conditioning system for the motor vehicle, for example. The processing device 11 of the system 20 is arranged to the right of the motor vehicle component 1. Said processing device may be arranged, for example, in the area of the glove compartment or airbag of the front passenger.

The visual output device 7 is arranged in the immediate field of vision of the driver. In this example, said output device extends from the speedometer display to the centrally arranged navigation-multimedia unit of the motor vehicle. While the user of the motor vehicle is driving the vehicle, they may target the output device 7 in a field of vision 10 of the user. In this case, a first parameter P1 and a second parameter P2 are presented in a predetermined area 8 of the output device 7. The first parameter P1 indicates a first adjustment of the motor vehicle component 1 and the second parameter P2 indicates a second adjustment of the motor vehicle component 1. An image capturing device 9 arranged above the rear-view mirror is used to track the user's field of vision and, in particular, to ascertain focus points. If the user visually focuses the second parameter P2 on the output device 7 when the user performs the second user input, the system 20 establishes that the user wants to execute the second parameter P2 and thus the second adjustment of the vehicle component 1. For example, the driving mode can be changed from an eco mode to a sports mode.

Overall, the examples show how a method for adjusting a motor vehicle component, a system, a computer program, a computer-readable storage medium and a motor vehicle can be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

1 Motor vehicle component
2 Body part of the user
3 Sensor device
4 Capacitive sensor
5 Infrared sensor
6 Motion sensor
7 Visual output device
8 Predetermined area of the output device
9 Image capturing device
10 Field of vision
11 Processing device
12 Center console
20 System
100 Method
P1 First parameter
P2 Second parameter

1. A method of adjusting a motor vehicle component of a motor vehicle, comprising:
detecting, by a capacitive sensor of a sensor device, a first user input of a user;
presenting, by a processing device, a first parameter and a second parameter by a visual output device based on the first user input in an area, the first parameter indicating a first adjustment of the motor vehicle component and the second parameter indicating a second adjustment of the motor vehicle component;
ascertaining, by an image capturing device, a field of vision visually targeted as a targeted field by the user in the area of the visual output device depending on a time when the first parameter and the second parameter have been presented;
determining, by the processing device, a parameter selected by the user based on the targeted field of vision depending on a spatial arrangement of the first parameter and the second parameter in the field of vision of the user, the parameter selected corresponding either to the first parameter or to the second parameter;
establishing, by the image capturing device, a second user input of the user by the sensor device depending on a time when the targeted field of vision of the user has been ascertained by the image capturing device; and
adjusting, by the processing device, the motor vehicle component based on the parameter selected by the user after the second user input has been established.

2. The method according to claim 1, wherein the sensor device is a rotary pushbutton.

3. The method according to claim 1, wherein the sensor device is arranged in an operating position in the motor vehicle in an area of a central console.

4. The method according to claim 1, wherein the sensor device comprises an infrared sensor configured to ascertain a distance from a body part of the user.

5. The method according to claim 4, further comprising:
by the image capturing device and/or the processing device perform at least one step among steps, within a period of time when a distance of a body part of the user ascertained by the infrared sensor falls below a threshold value, including:
ascertaining the field of vision visually targeted by the user,
determining the parameter selected by the user, or
establishing the second user input of the user.

6. The method according to claim 5, further comprising:
identifying a movement of the body part of the user during the first user input detected by the sensor device.

7. The method according to claim 6, wherein the identifying the movement is carried out based on the capacitive sensor and/or the infrared sensor of the sensor device.

8. The method according to claim 7, wherein the body part is a plurality of body parts and the method further comprises:
identifying the plurality of body parts of the user used by the user when the first user input is detected and/or when the second user input is established.

9. The method according to claim 8, wherein the identifying of the plurality of body parts is carried out based on the capacitive sensor and/or the infrared sensor of the sensor device.

10. The method according to claim 1, wherein the establishing of the second user input is carried out by at least one sensor among sensors of the sensor device including:
the capacitive sensor,
an infrared sensor, or
a motion sensor configured to establish a movement of the sensor device.

11. A system for adjusting a motor vehicle component of a motor vehicle, comprising:
a sensor device configured to detect a first user input of a user by a capacitive sensor;
a visual output device configured to present a first parameter and a second parameter based on the first user input in an area, the first parameter indicating a first adjustment of the motor vehicle component and the second parameter indicating a second adjustment of the motor vehicle component;
an image capturing device configured to ascertain a field of vision visually targeted as a targeted field of vision by the user in an area of the visual output device depending on a time when the first parameter and the second parameter have been presented;
a processing device configured to determine a parameter selected by the user based on the targeted field of vision depending on a spatial arrangement of the first parameter and the second parameter in the field of vision of the user, the parameter selected corresponding either to the first parameter or to the second parameter,
wherein
the sensor device is configured to establish a second user input of the user depending on a time when the targeted field of vision of the user has been ascertained by way of the image capturing device, and
the processing device is configured to adjust the motor vehicle component based on the parameter selected by the user after the second user input has been established.

12. A non-transitory computer-readable storage medium, comprising instructions which, when executed by a computer, cause the computer to perform the method according to claim 1.

13. A motor vehicle, comprising a system configured to execute the method according to claim 1.
